(19) United States
(12) Patent Application Publication
(10) Pub. No.: US 2025/0127327 A1
(43) Pub. Date: Apr. 24, 2025

(54) SMART KITCHEN TIMER SYSTEM

(71) Applicant: Renau Corporation, Chatsworth, CA (US)

(72) Inventors: KAROL RENAU, Calabasas, CA (US); Michael Renau, West Hills, CA (US)

(21) Appl. No.: 18/919,774

(22) Filed: Oct. 18, 2024

Related U.S. Application Data
(60) Provisional application No. 63/544,749, filed on Oct. 18, 2023.

(51) Int. Cl. A47J 36/32; G09B 19/00

(52) U.S. Cl. CPC A47J 36/32; G09B 19/00

(57) ABSTRACT

A smart kitchen timer system is provided. The smart kitchen timer system comprises a system for and a method of providing a smart kitchen timer control environment and solution for easily communicating steps or instructions regarding food preparation or task that is further straightforwardly adaptable and suitable for a commercial kitchen environment. The smart kitchen timer features a comprehensive kitchen management and monitoring solution which utilizes digital tiles in place of typical channels found on existing kitchen times and assist users in properly performing processes in a commercial kitchen environment.

### CROSS-REFERENCE TO RELATED APPLICATIONS

This application claims priority pursuant to 35 U.S.C. 119(e) to co-pending U.S. Provisional Patent Application Ser. No. 63/544,749, filed Oct. 18, 2023, the entire disclosure of which is incorporated herein by reference.

### FIELD OF THE INVENTION

The present invention relates generally to systems and methods interrelated to and in connection with smart kitchen controls. More specifically, the present invention is concerned with systems and methods utilizing a dynamically configurable Smart Kitchen Timer and Smart Kitchen Control system.

### BACKGROUND

The food service industry, namely commercial kitchens and restaurants, face numerous challenges regarding, or related to, managing food supply chains, food safety, food freshness trackability, food safety education and/or training, food safety cultures, operational consistency, among many more. Moreover, failure to strictly comply with stringent food safety guidelines, policies, or practices, often results in unsafe food handling, improper food storage, or incorrect food preparation, in which failing to adhere to any of the foregoing may result in foodborne illness outbreaks, such as microbial food poisoning.

While several food preparation and cooking control methods are available, these current systems are often used in an inconsistent manner and frequently fail due to, inter alia, the human error aspect. Accordingly, and often attributable to human error, studies have indicated that most foodborne illness outbreaks, with respect to commercial kitchens or restaurants, can be linked to shortcomings related to the failure of properly managing food associated processes and/or inadequately maintaining procedures. Moreover, these risk factors are often correlated with, either or both, food workers' improperly preparing food or engaging in unsafe food preparation practices.

In efforts to contribute a solution, or at least mitigate some shortcomings, associated with practices and factors affecting food preparation or process, current systems exist which remove some errors attributable to food preparation or managing personnel. However, each of these current systems suffer from limitations or disadvantages not addressed by the current state of art and it only takes one mistake regarding proper time or temperature to create a foodborne illness, causing both future lost revenues for the commercial kitchen or restaurant and possibly instils a lasting negative impression on customers.

For example, some current systems implement timers to help food workers achieve consistent results, by attempting to ensure that food items are cooked to the desired level of doneness. However, traditional kitchen timer solutions suffer from a lack of accuracy because they must be monitored manually by the respective food preparation personal and further utilize devices such as a physical stopwatch, wall clock, single channel timers, or the like. Other existing kitchen timer solutions utilize channels and have dedicated light emitting diode displays for each channel or one display for the time value, and another for the current channel. Moreover, these type of commercial kitchen timers come in 2, 4, 8, 12, and 1 channel models. Unfortunately, such systems often suffer from a lack of functionality and usability because each of these channels represents a food item or ingredient, and limits users to programming up to the set number of channels. Accordingly, it would be beneficial to have a system for and a method of a smart kitchen timer which overcomes the limits and deficiencies associated with traditional kitchen timers and channel-based timers.

Another example of existing kitchen control or management systems, include systems that comprise defined task or list that include the food preparation worker's duties or steps needed for preparing the certain food item. However, these traditional food preparation task systems or methods employ hand-written or typed list, verbal instructions, inconveniently mounted digital displays, and further include steps or procedures that are difficult to modify as the requirements associated with differing food items must often be changed or edited. Additionally, today's environment with respect to commercial kitchens and restaurants force both food preparation employees and managers to complete various tasks beyond their primary role, thereby stretching normal duties thin and creating a greater potential for human errors. Accordingly, it would be beneficial to have a system for and a method of easily communicating steps or instructions regarding food preparation or task that is further straightforwardly adaptable and suitable for a commercial kitchen environment.

In another example, some existing solutions require personnel manually taking and measuring values corresponding to a food item's temperature with traditional temperature measuring devices, such as a traditional glass mercury thermometer or a battery-operated thermometer. However, using manual temperature measuring devices can be time consuming and recording the data can be challenging, which further increases the possibility for human errors. Accordingly, it would be beneficial to have a system for and a method of determining, tracking, or recording, a food items temperature that eliminates or otherwise limits the influence of human errors, associated labor burden, and is further adaptable for a plurality of requirements associated with differing food items.

As each commercial kitchen or restaurant is unique to itself, each facility often requires equally exclusive kitchen control systems that are easily adaptable for their specific needs and many factors must be taken into consideration. However, existing solutions often fail to include modularity or merely offer limited usability with respect to either adaptability or the type of interface devices (e.g., sensors or external devices). Accordingly, it would be beneficial to have a system and method that offers a plurality of reminders or prompts based from timing, monitoring, proximity, and/or sensing that is capable of being recorded or communicated to a respective user with a high level of accuracy. Moreover, it would further be beneficial to have a system and method that comprises modularity such that it offers flexibility with respect to interface devices and/or other appliances and is capable of being interfaced with a plurality of sensors, external devices, displays, or the like.

Providing adequate food safety training to employees, managers, and other personnel that may be a part of food preparation or food handling is essential to protecting customers from foodborne illnesses and is a critical component to a successful foodservice program. However, proper training can often be difficult to manage and maintain as this specific industry typically suffers from a high employee turnover rate. While other solutions exist specific for food preparation and/or food handling, such solutions are difficult to implement as with the high employee turnover rate and fail to include the level customization needed for each unique commercial kitchen or restaurant. Consequently, it would be beneficial to have a system for and a method of employee training that is capable of being fully customized, repurposed as needed, and documented as needed for reporting purposes.

Managing the above-mentioned aspects is a difficult task due to the numerous factors associated with food safety and it is unwise to rely solely on experience. Moreover and in addition to the foregoing, existing solutions fail to present a system or method that provide a single control system that envelops an all-in-one solution and existing systems often suffer from a lack of functionally with respect to: labeling; re-ordering food items; scheduling equipment maintenance; maximizing security regarding trade secrets, customer/client information, receipt information, financial and/or related information; capability of being remotely controlled and monitored; providing insights into the respective appliances/processes; contributing to commercial kitchen or restaurant increased efficiency and functionally; and among many more. Accordingly, it would be beneficial to have a system and method that eliminates or otherwise limits the influence of human error in addition to providing an all-in-one solution utilizing a dynamically adaptable and configurable Smart Kitchen Timer control system that, inter alia: monitors and track dates corresponding to food freshness; manages food extirpation dates; reduces or eliminates unsafe food handling by employees (e.g., failure to practice adequate hand washing); reduces or eliminates food cross contamination; assists with cooking food to the right temperature, maintaining heated food hot or cooled food cold; provides adequate and repeatable employee training/support; helps ensure that personnel follow food preparation steps/procedures; and aids in maintaining cooking equipment.

### SUMMARY

The present invention comprises inventions and systems related to smart kitchen controls, timers, and displays. Moreover, the present invention comprises a system for and method of providing unified commercial food quality and freshness regarding, inter alia, food tracking; temperature and environmental monitoring; the identification, evaluation, and control of food safety hazards (HACCP monitoring and management); employee task and reminder management; employee training; local alert and notification generation; Cloud connectivity for remote alerts and monitoring; both local and remote monitoring and status reporting; and enhancing existing food safety and labeling programs.

The present invention further comprises a system for and a method of providing a Smart Kitchen Timer control environment and solution.

Furthermore, the present invention eliminates the deficiencies associated with traditional kitchen timers and channel-based timers.

Furthermore, the present invention provides a system and method for easily communicating steps or instructions regarding food preparation or task that is further straightforwardly adaptable and suitable for a commercial kitchen environment.

Furthermore, the present invention provides a system for and a method of determining, tracking, or recording, a food items temperature that eliminates or otherwise limits the influence of human errors, associated labor burden, and is further adaptable for a plurality of requirements associated with differing food items.

Furthermore, the present invention provides a system and method that offers a plurality of reminders or prompts based off of timing, monitoring, proximity, and/or sensing that can be recorded or communicated to a respective user with a high level of accuracy.

Furthermore, the present invention provides a system and method that comprises modularity such that it offers flexibility with respect to interface devices and/or other appliances and is capable of being interfaced with a plurality of sensors, external devices, displays, or the like.

Furthermore, the present invention provides a system for and a method of employee training that can be fully customized, repurposed as needed, and documented as needed for reporting purposes.

Furthermore, the present invention provides a system and method that eliminates or otherwise limits the influence of human error in addition to providing an all-in-one solution utilizing a dynamically adaptable and configurable Smart Kitchen Timer control system.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

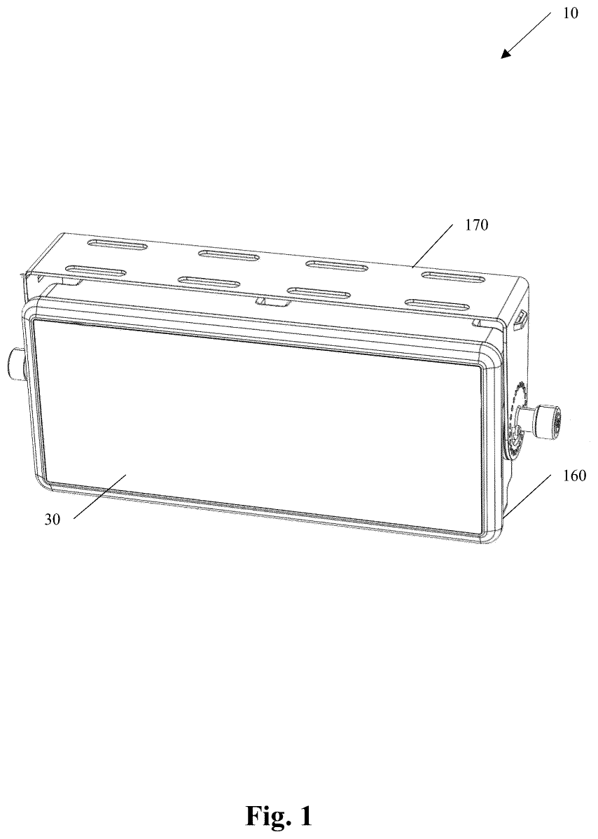

FIG. 1 is a perspective view of smart kitchen timer of the instant invention and in which embodiments of the instant invention may be incorporated.

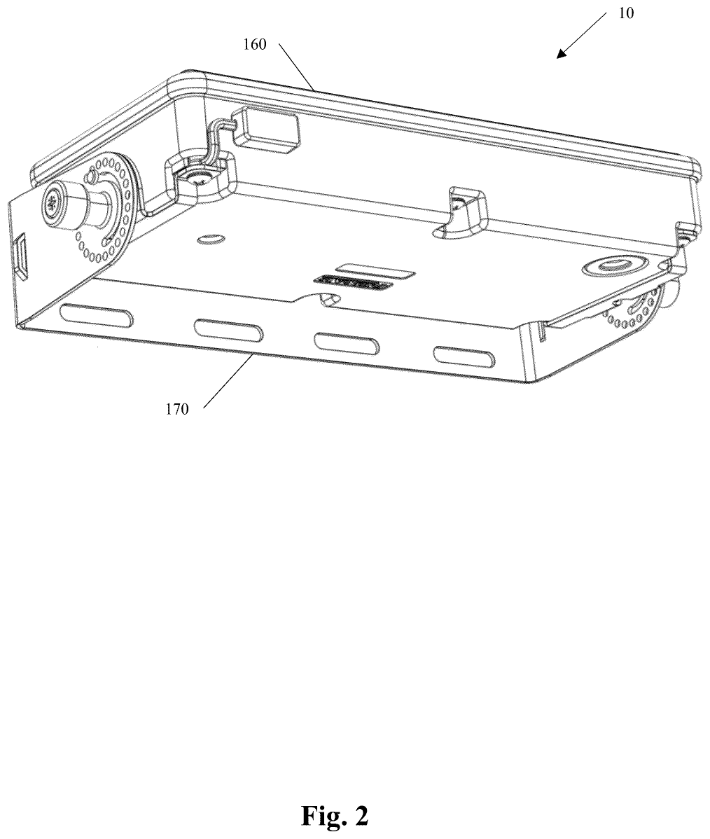

FIG. 2 is a perspective view of smart kitchen timer of the instant invention and in which embodiments of the instant invention may be incorporated.

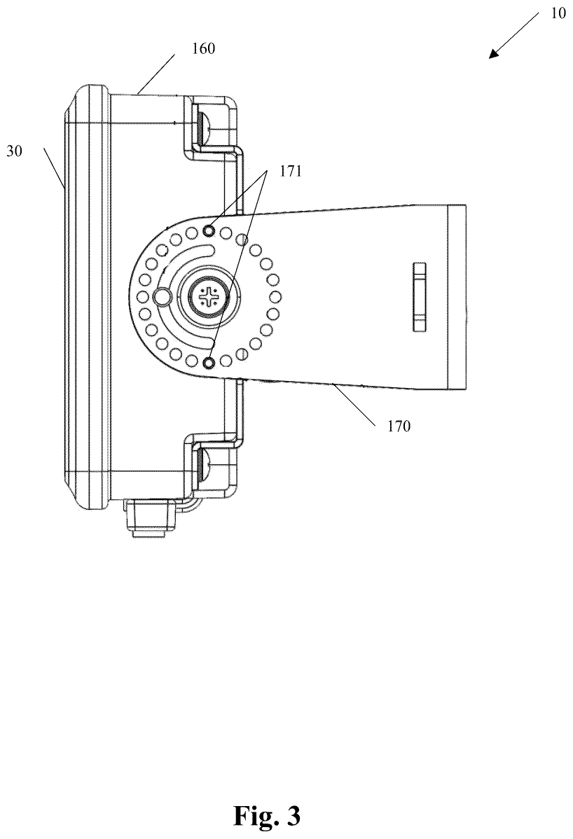

FIG. 3 is a perspective view of smart kitchen timer of the instant invention and in which embodiments of the instant invention may be incorporated.

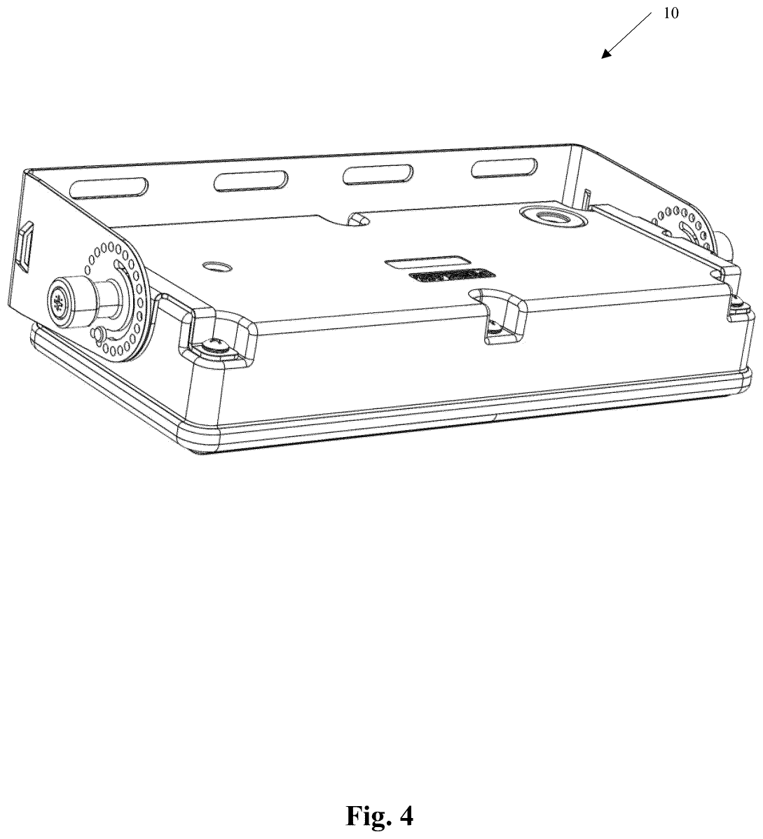

FIG. 4 is a perspective view of smart kitchen timer of the instant invention and in which embodiments of the instant invention may be incorporated.

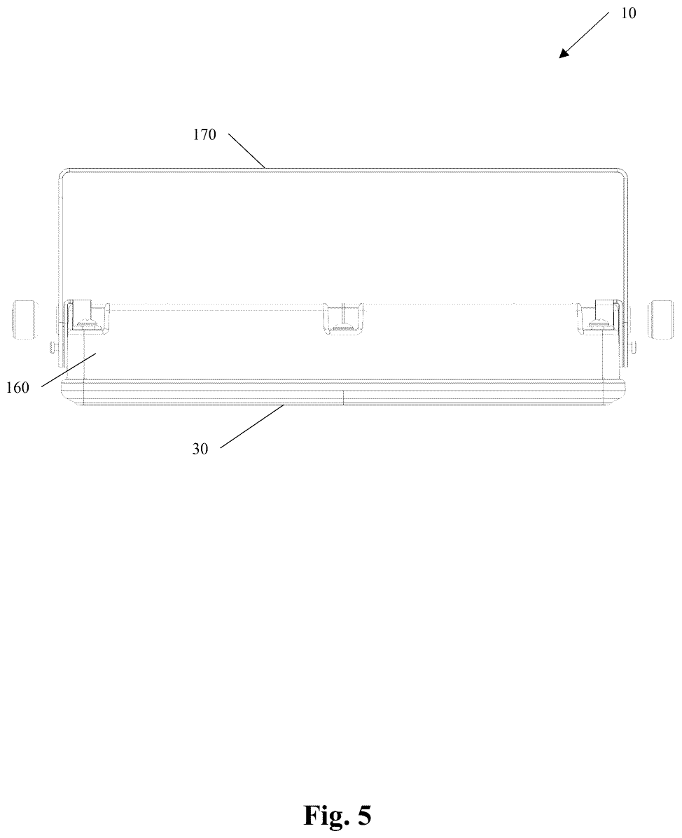

FIG. 5 is a perspective view of smart kitchen timer of the instant invention and in which embodiments of the instant invention may be incorporated.

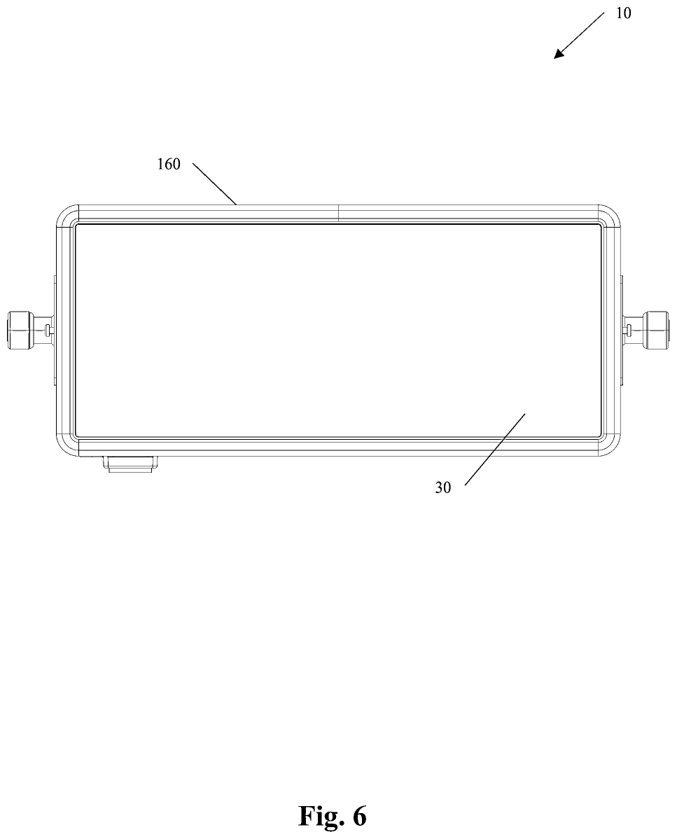

FIG. 6 is a perspective view of smart kitchen timer of the instant invention and in which embodiments of the instant invention may be incorporated.

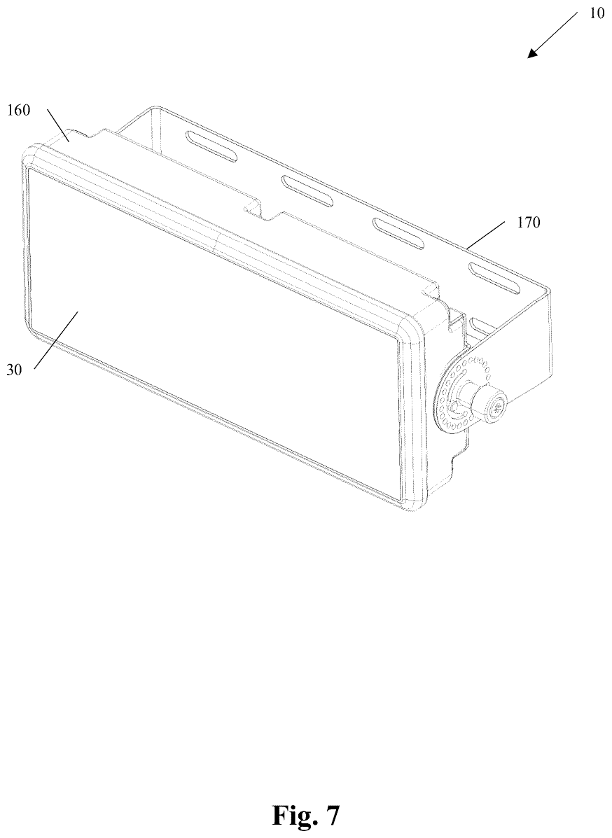

FIG. 7 is a perspective view of smart kitchen timer of the instant invention and in which embodiments of the instant invention may be incorporated.

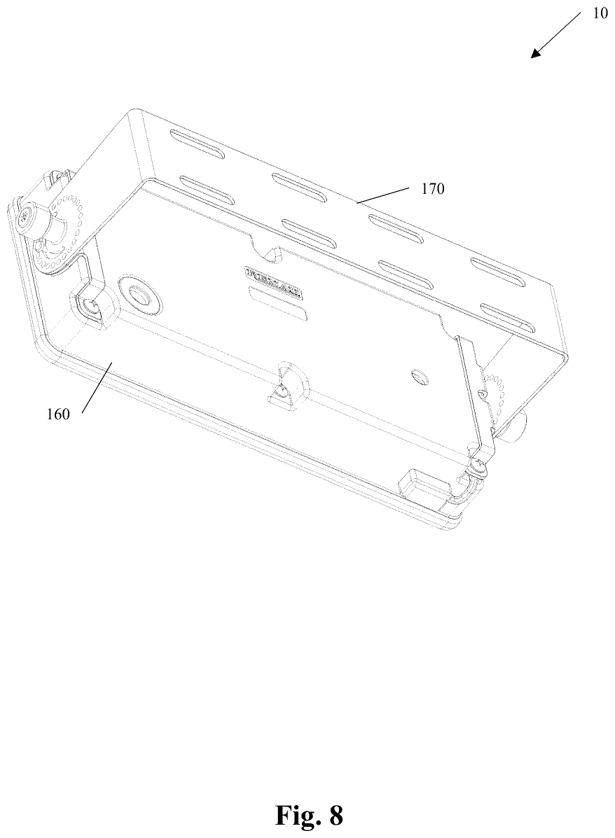

FIG. 8 is a perspective view of smart kitchen timer of the instant invention and in which embodiments of the instant invention may be incorporated.

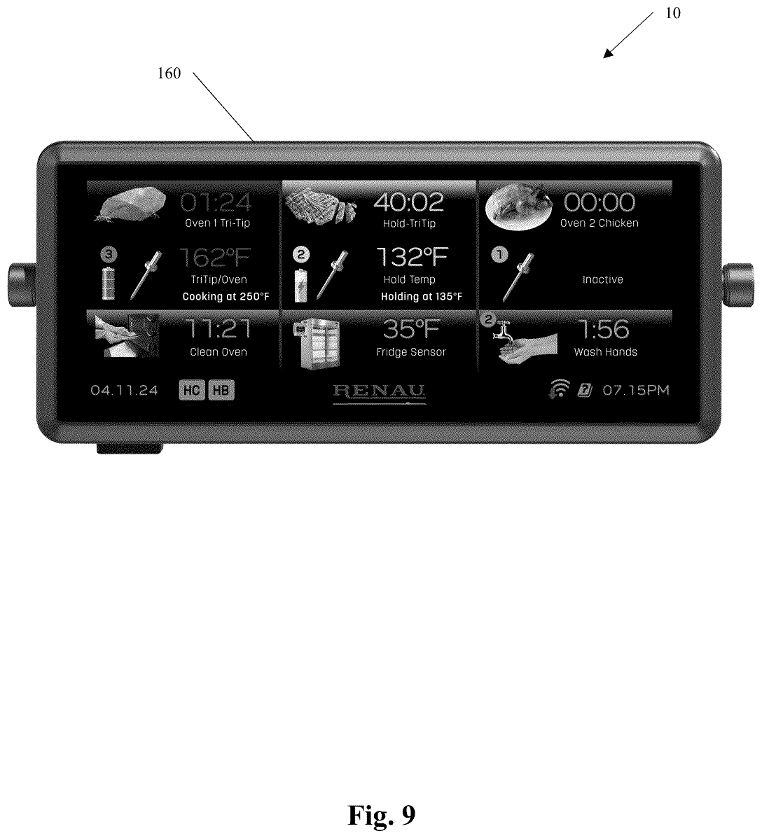

FIG. 9 is a perspective view of smart kitchen timer of the instant invention and in which embodiments of the instant invention may be incorporated.

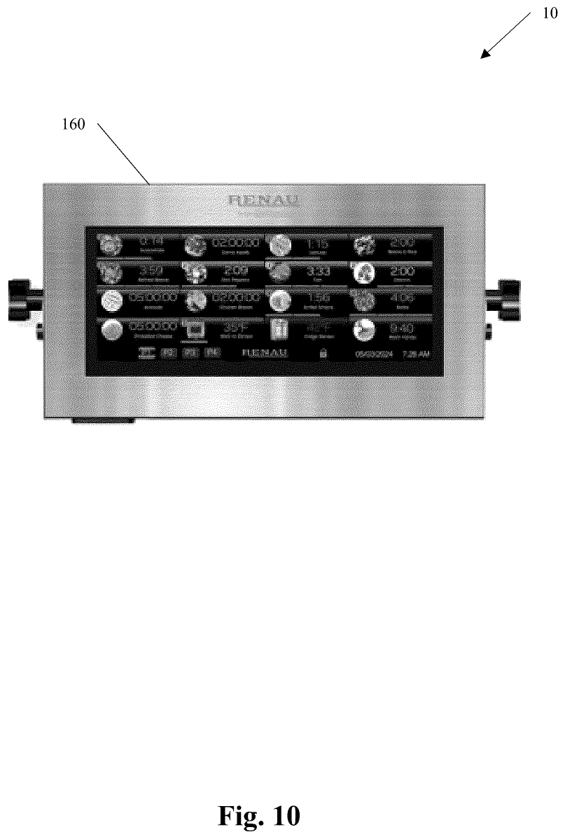

FIG. 10 is a perspective view of smart kitchen timer of the instant invention and in which embodiments of the instant invention may be incorporated.

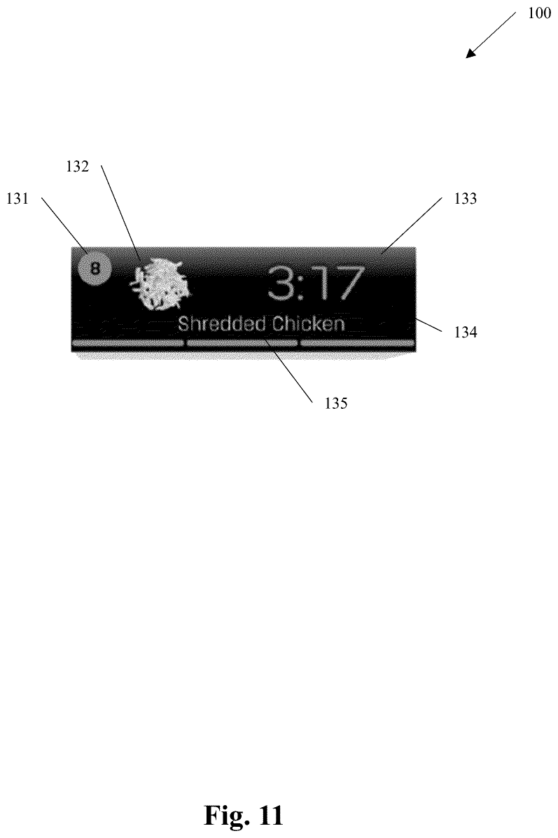

FIG. 11 is a representation of an embodiment of a tile of the instant invention.

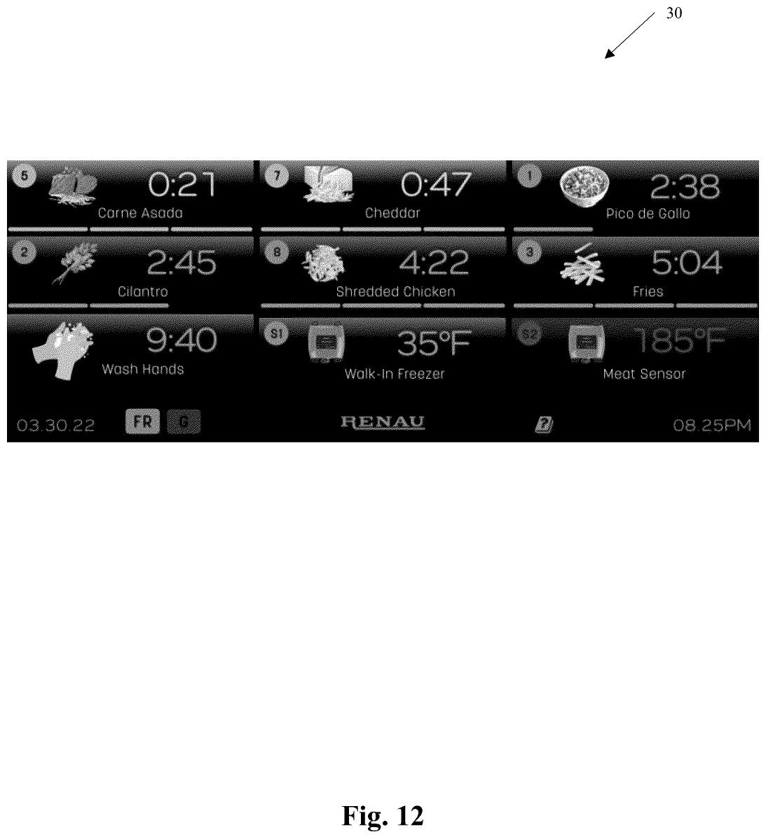

FIG. 12 is a representation of an embodiment of a plurality of tiles depicting on a display of the instant invention.

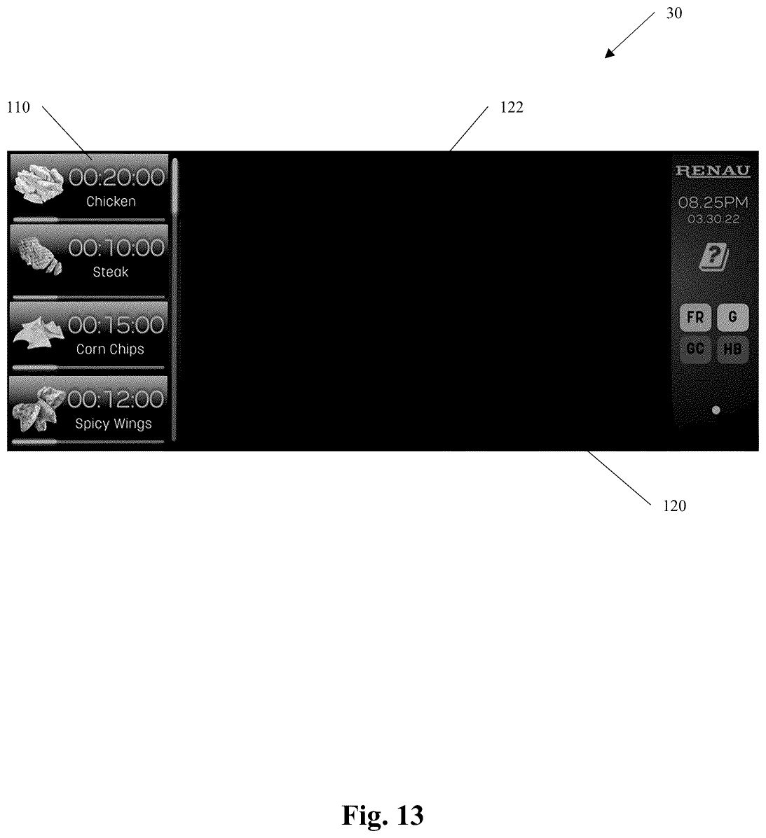

FIG. 13 is a representation of an embodiment a display depicting static tiles, dynamic tiles, and a playfield area of the display of the instant invention.

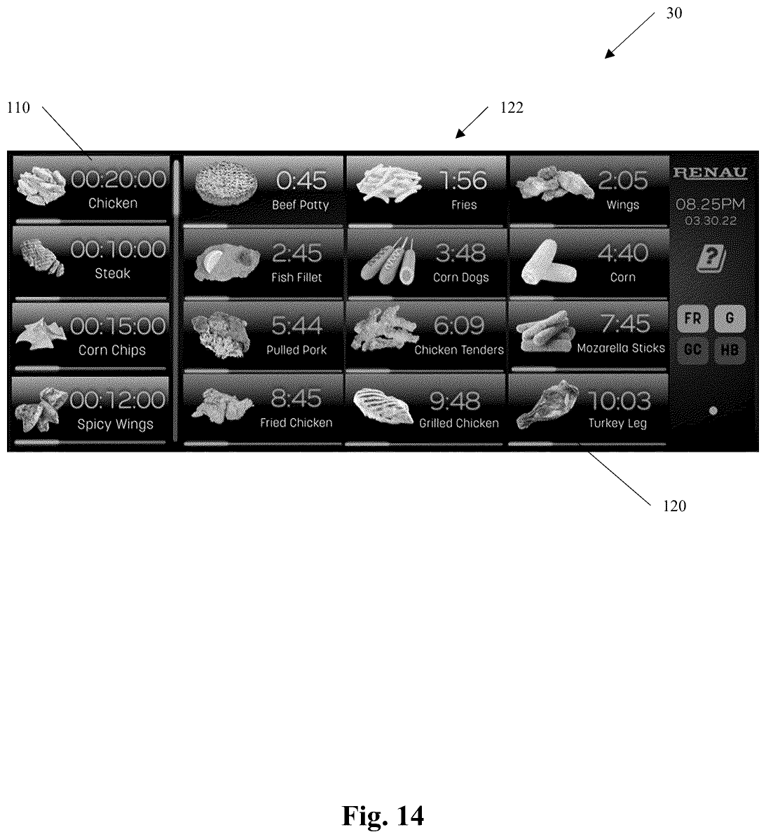

FIG. 14 is a representation of an embodiment a display depicting static tiles, dynamic tiles, and a playfield area of the display of the instant invention.

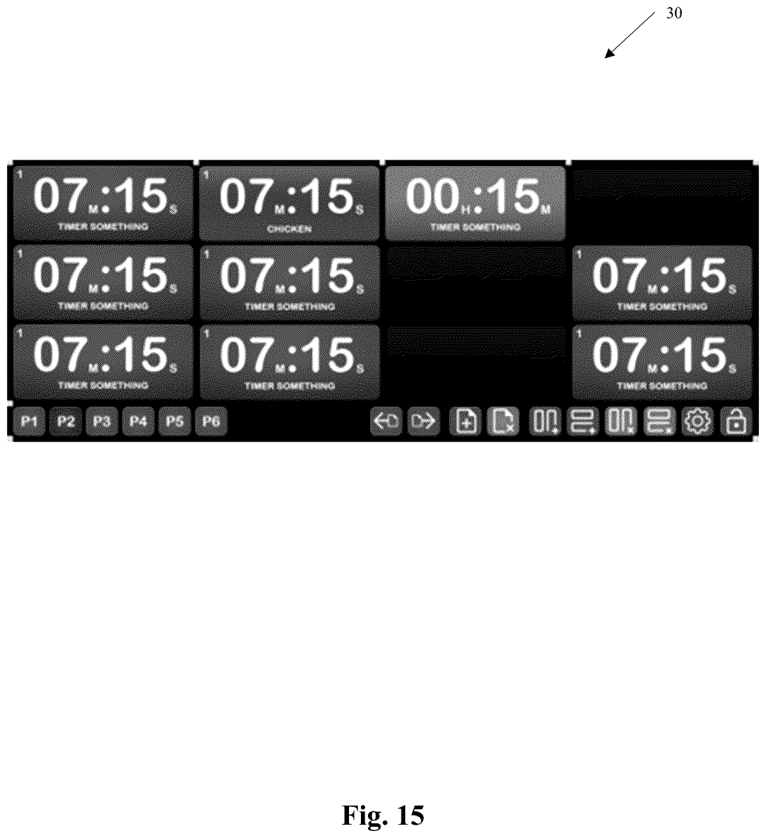

FIG. 15 is a representation of an embodiment of a SKT Basic software application and a basic user interface application screen configured on the display of the instant invention.

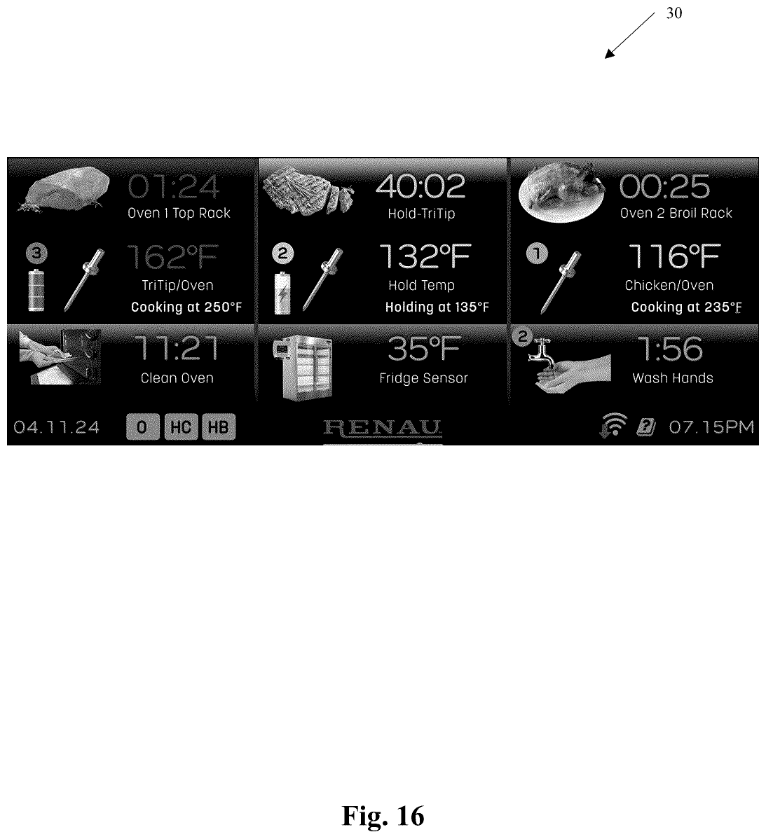

FIG. 16 is a representation of an embodiment of a SKS Hub software application and an advanced user interface application screen configured on the display of the instant invention.

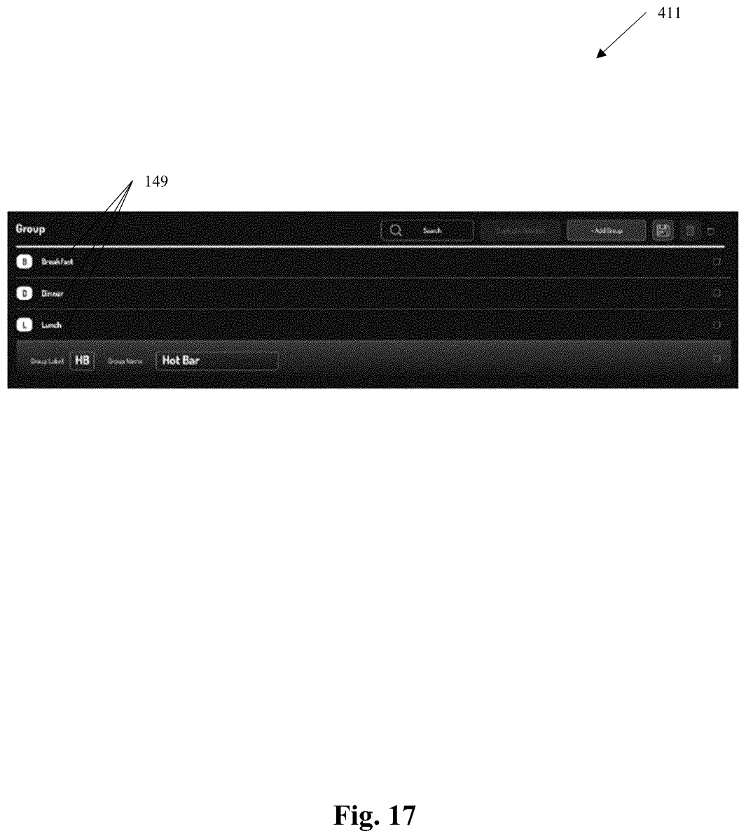

FIG. 17 is a representation of an embodiment of a food group configuration window relevant to the present inventive concept.

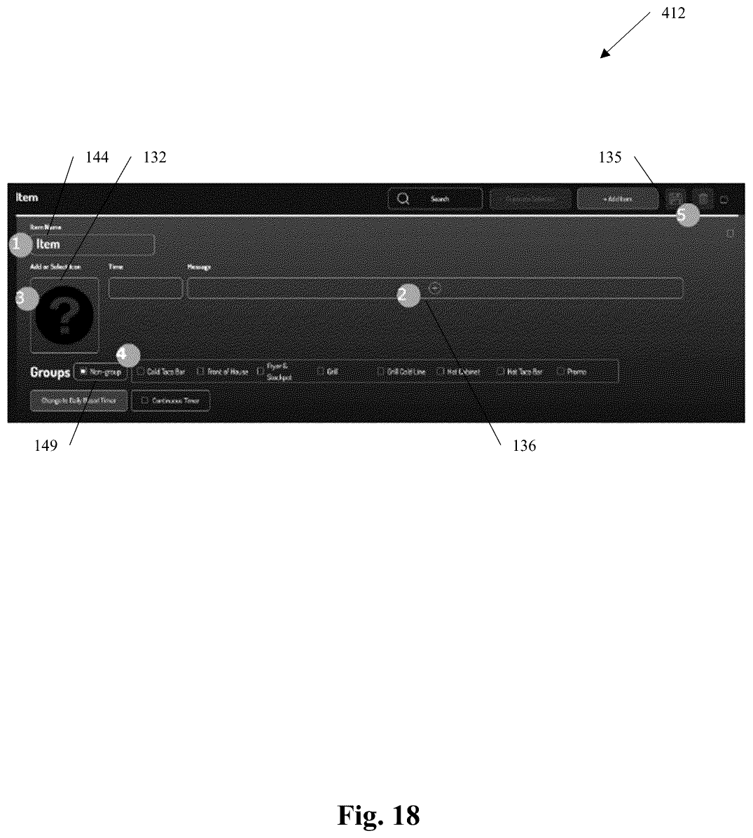

FIG. 18 is a representation of an embodiment of a food item configuration window relevant to the present inventive concept.

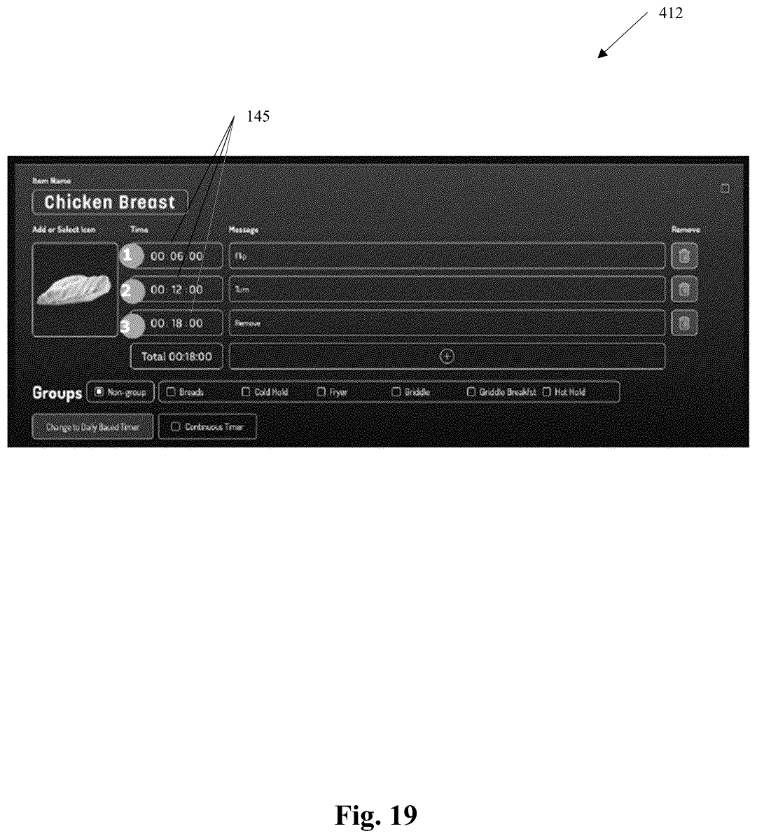

FIG. 19 is a representation of an embodiment of a food item configuration window depicting a plurality of duty cycles relevant to the present inventive concept.

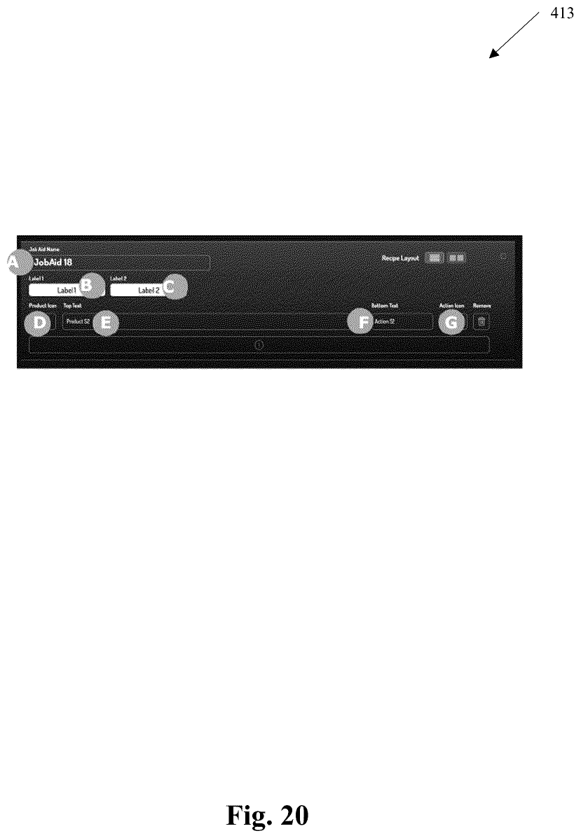

FIG. 20 is a representation of an embodiment of a job aid configuration window depicting a plurality of duty cycles relevant to the present inventive concept.

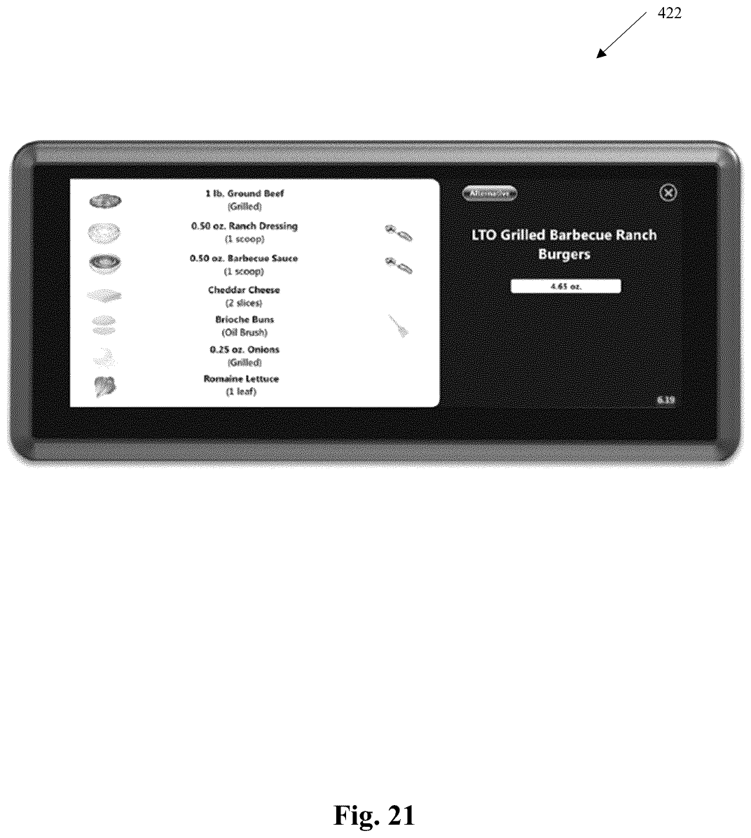

FIG. 21 is a representation of an embodiment of a job aid relevant to the present inventive concept.

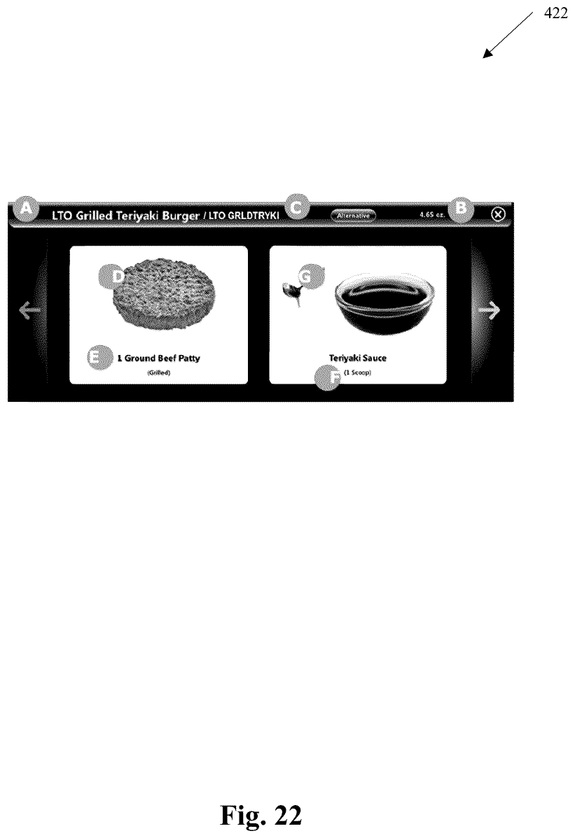

FIG. 22 is a representation of an embodiment of a job aid relevant to the present inventive concept.

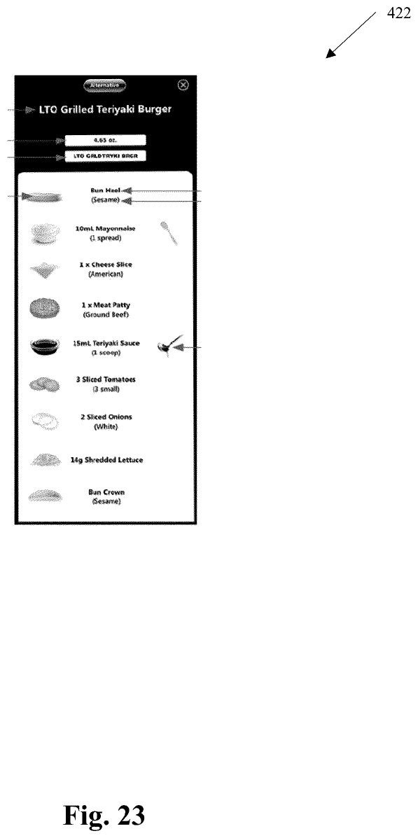

FIG. 23 is a representation of an embodiment of a job aid relevant to the present inventive concept.

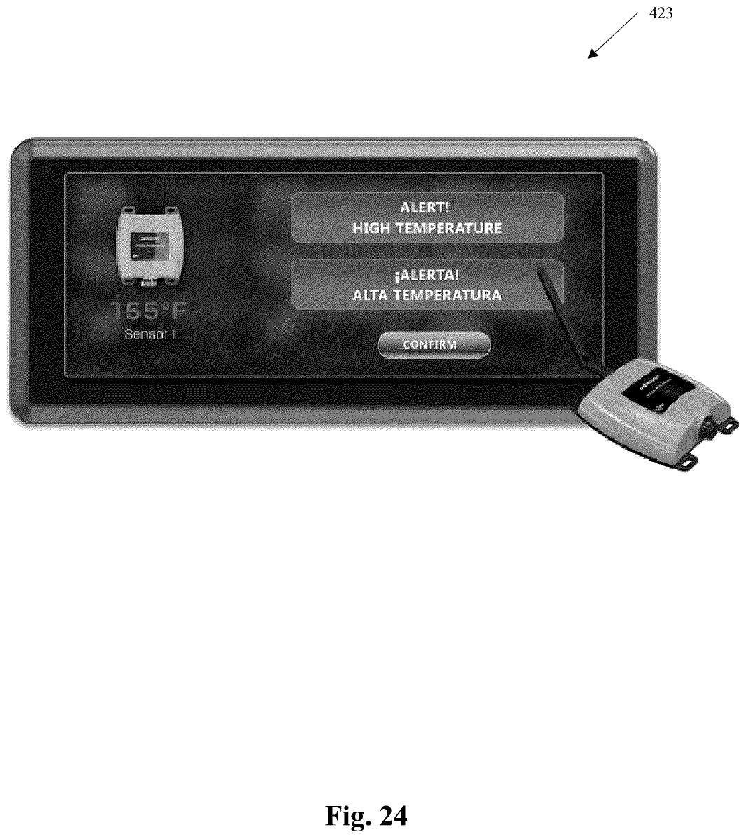

FIG. 24 is a representation of an embodiment of a message relevant to the present inventive concept.

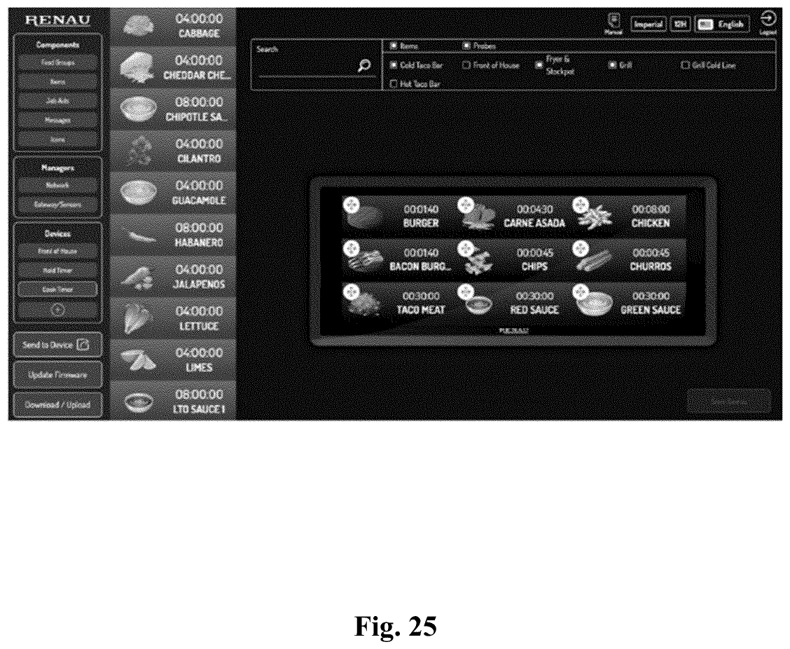

FIG. 25 is a representation of an embodiment of a configuration tool configuration window relevant to the present inventive concept.

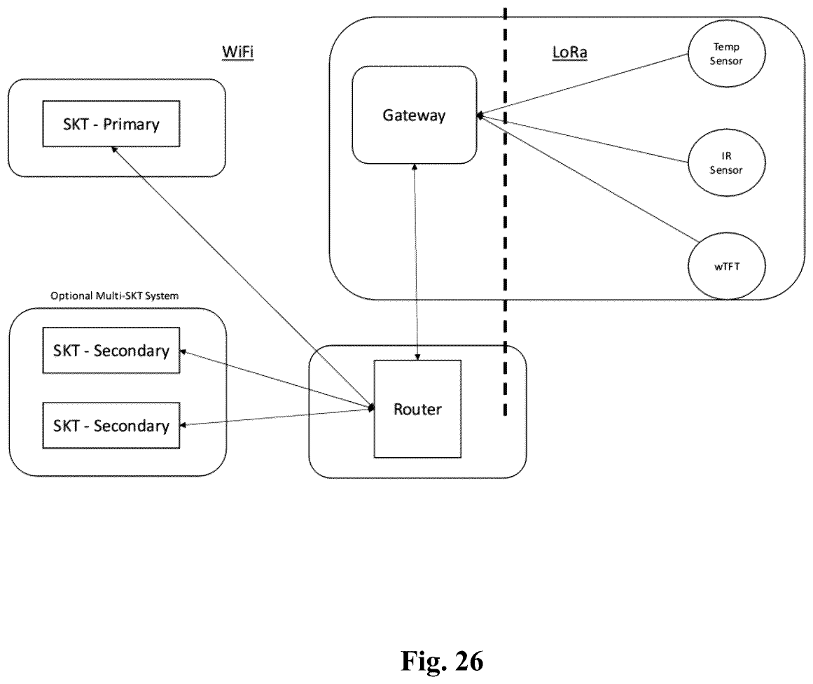

FIG. 26 is a diagrammatic view of embodiments of the control system for food items, smart kitchen controls, and environmental monitoring system relevant to the present inventive concept.

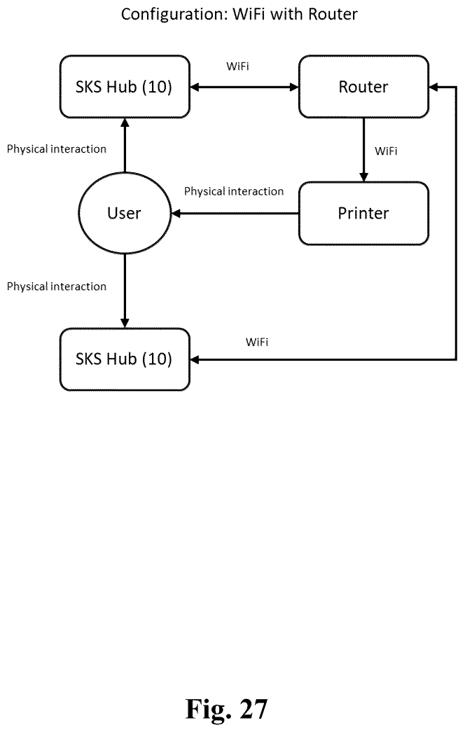

FIG. 27 is a diagrammatic view of embodiments of the control system for food items, smart kitchen controls, and environmental monitoring system relevant to the present inventive concept.

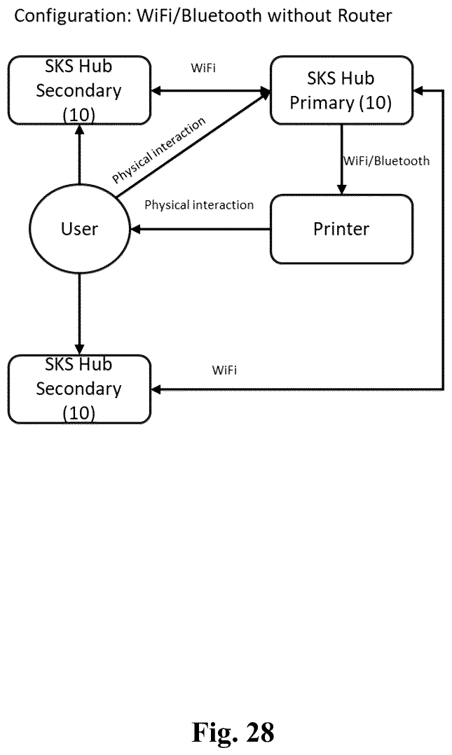

FIG. 28 is a diagrammatic view of embodiments of the control system for food items, smart kitchen controls, and environmental monitoring system relevant to the present inventive concept.

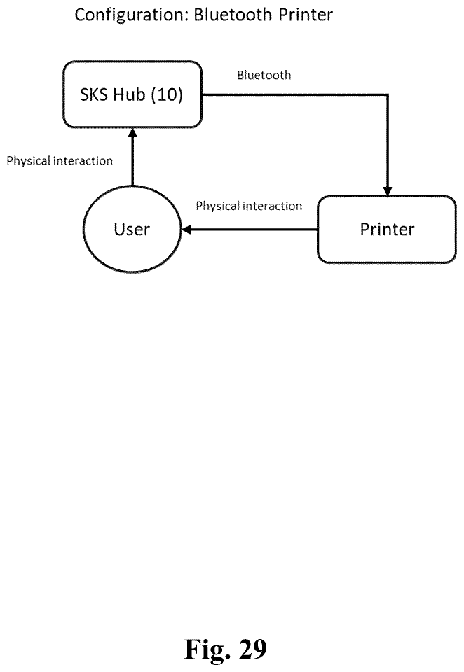

FIG. 29 is a diagrammatic view of embodiments of the control system for food items, smart kitchen controls, and environmental monitoring system relevant to the present inventive concept.

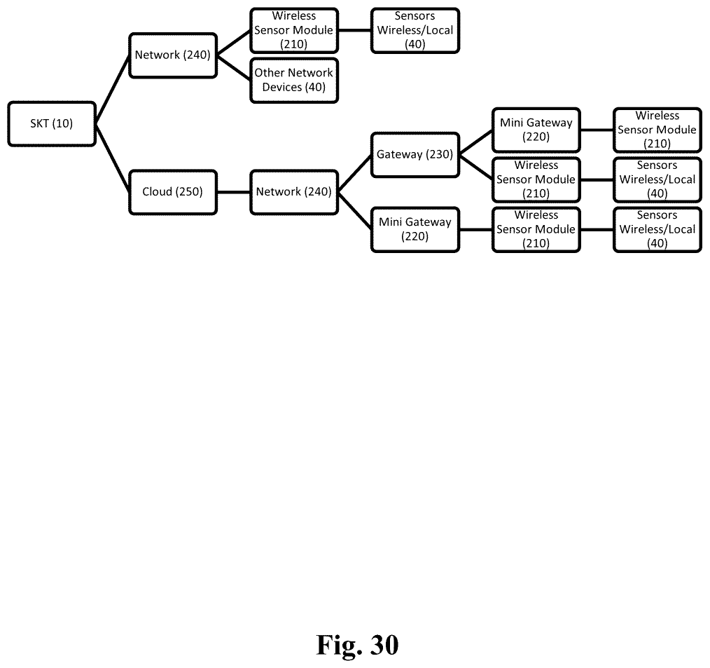

FIG. 30 is a diagrammatic view of embodiments of the control system for food items, smart kitchen controls, and environmental monitoring system relevant to the present inventive concept.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIGS. 1-30, each of which depict illustrations and examples of embodiments of this invention and various features thereof.

The present invention comprises a dynamic Smart Kitchen Timer (“SMART KITCHEN TIMER”) control system and method. In an exemplary embodiment of the present invention, the SMART KITCHEN TIMER 10 includes, but is not limited to, a suite of devices, appliances, or systems that connect into a common network that is capable of being independently and/or remotely controlled. It is an object of some embodiments of the present invention to provide a device and method for a universal kitchen timer with the ability for a single unit to handle every timed event, process, and task in a commercial kitchen. It is another object of some embodiments of the instant invention to provide system and methods configured for controlling and/or operating a commercial kitchen appliance, equipment, device, or the like. Yet in other embodiments, the present invention is configured to enable users to connect, control, monitor, a commercial kitchen appliance, equipment, device, or the like.

In some embodiments, the SMART KITCHEN TIMER 10 includes a housing 160. In some embodiments, the housing 160 is made from plastic, metal, or the like; however, other suitable materials are contemplated in various embodiments of the inventive concept. In some embodiments of the instant invention, the housing 160 prevents the internally mounted devices, such as electronic components, from being fouled by outside debris. In other embodiments, the housing 160 is designed to protect, contain, and enclose electronic components, such as switches, processors, relays, printed circuit boards, or the like. In some embodiments of the instant invention, the housing 160 comprises ingress protection against solids and/or liquids. In some embodiments of the instant invention, the housing 160 includes integrated fittings or brackets to keep the internal components in place and for mounting the internal components. In some embodiments of the instant invention, the housing 160 ingress protection is IP65 or higher. Yet in another embodiment, the present invention has an rated rugged design which is fully encapsulated.

In some embodiments of the present invention, the housing 160 is configured for adapting or mounting to a bracket 170. In a preferred embodiment of the instant invention, the bracket 170 is configured for being movable within, but not limited to, 180 degrees of rotation and is adjustable at 15-degree increments. In another embodiment of the instant invention, the bracket 170 includes one or more alignment pins 171 being utilized for securing the SMART KITCHEN TIMER 10 in a fixed position. In some embodiments, the bracket 170 is made from metal; however, other suitable materials are contemplated in various alternative embodiment of the invention. In some embodiments, the bracket 170 allows the SMART KITCHEN TIMER 10 to move in a plurality of orientations, such as vertically, horizontally, rotationally, or in combination of any of the aforementioned directions.

In other embodiments, the present invention is utilized in a vertical orientation, such that the display unit 30 is in line with, or parallel to, a vertical axis. In other embodiments, the present invention is utilized in a horizontal orientation, such that the display unit 30 is in line with, or parallel to, a horizontal axis. Yet in other embodiments of the present invention, the instant invention is utilized in other orientations that are neither complete vertical nor horizontal.

In some embodiments of the instant invention, the SMART KITCHEN TIMER 10 includes an electronic display unit 30. In one embodiment, the display unit 30 is an electronic visual display device. In other embodiments of the instant invention, the display unit 30 comprises a screen being configured for rendering electronic images, text, graphics, icon, or the like. In some embodiments, the display unit 30 produces the rendering of electronic images, text, graphics, icon, or the like, is depicted in color or black and white. In another embodiment of the instant invention, the display unit 30 is integrally mounted to the housing 160. In some preferred embodiments, the display unit 30 includes a screen being configured for receiving inputs from a user, such as being configured as a touch screen. In some embodiments, the display unit 30 is configured with an ingress protection rating equivalent or greater to the housing ingress protection rating. In some embodiments of the instant invention, the display unit 30 ingress protection is IP65 or higher. Yet in another embodiment of the present invention, the display unit 30 comprises a touchscreen that is glove safe. In other embodiments of the instant invention, the display unit 30 is a dynamic user interface.

In an exemplary embodiment, the instant invention is configured to receive one or more input. In some embodiments, the one or more input is an external device 40, such as a sensor being configured for measuring temperature, humidity, moisture, or the like. In another embodiment, the one or more inputs is received via an electronic display 30, such as a touchscreen. In another embodiment, the one or more inputs is an electronic signal, being either a digital signal or an analog signal.

In some embodiments of the instant invention, a SMART KITCHEN TIMER 10 provides for the pairing of wireless sensor modules. In other embodiments, the wireless sensor modules provide the SMART KITCHEN TIMER 10 with the ability to monitor and/or set alerts and/or messages. In some embodiments, sensors are wirelessly connected to a wireless sensor module 210, wherein the wireless sensor module is wirelessly connected to a wireless mini gateway 220. In other embodiments, sensors are wirelessly connected to a wireless sensor module 210, wherein the wireless sensor module is wirelessly connected to a wireless gateway 230. In some embodiments, the mini gateway 220 is connected to a computer network 240. In other embodiments, a gateway 230 is connected to a computer network 240. In other embodiments, the sensor module 210 utilizes LoRaWAN for network communication. In some embodiments, the sensor module 210 is powered by batteries, such as two AA batteries. In other embodiments, the sensors utilize LoRaWAN for network communication.

In some embodiments, a gateway 230 is utilized to pair the wireless sensor modules 210. In other embodiments, a gateway 230 is utilized to pair the wireless sensors. In some preferred embodiments, a gateway 230 is an access point to a cloud computing network or environment 250. In some embodiments, a gateway 230 is connected to one or more access points, such as a router. In some embodiments, a gateway 230 enables a wireless sensor module 210 to electronically communicate with a cloud computing network or environment 250. In other embodiments, the cloud computing network or environment 250 is a proprietary system, such as the Renau Cloud. In some embodiments of the present invention, a user can create a unique account on the Renau Cloud and after the account, users can monitor all important equipment and parameters, and program conditional alerts sent via SMS, or email.

In some embodiments, a mini gateway 220 is utilized to pair the wireless sensor modules 210. In other embodiments, a mini gateway 220 is utilized to pair the wireless sensors. In some preferred embodiments, a mini gateway 220 is an access point to a cloud computing network or environment 250. In some embodiments, a mini gateway 220 is connected to one or more access points, such as a router. In some embodiments, a mini gateway 220 enables a wireless sensor module 210 to electronically communicate with a cloud computing network or environment 250. In other embodiments, the cloud computing network or environment 250 is a proprietary system, such as the Renau Cloud.

In one embodiment of the instant invention, the SMART KITCHEN TIMER 10, gateway 230, mini gateway 220, and sensor modules 210 are integrated via a cloud computing network or environment 250. In some embodiments, the sensor modules 210 are paired with a gateway 230 though a specially adapted system for wireless communication, such as a proprietary system for LoRa device detection. In some embodiments, the sensor modules 210 are paired with a mini gateway 220 though a specially adapted system for wireless communication, such as a proprietary system for LoRa device detection. In other embodiments, the sensor modules 210 are paired with a SMART KITCHEN TIMER 10 though a specially adapted system for wireless communication, such as a proprietary system for LoRa device detection. In another embodiment, the sensor modules 210 are paired with a cloud computing network or environment 250 though a specially adapted system for wireless communication, such as a proprietary system for LoRa device detection. In some embodiments, LoRa is a wireless modulation technique derived from Chirp Spread Spectrum technology.

In another embodiment, the present invention is configured for and being adapted to enable users to define and program one or more configuration type 140. In some embodiments, the present invention is configured to enable users to define and program duty cycles 145. In other embodiments, a configuration type 140 is a food group 149, food item 144, ingredient, task, reminder, message, process, timer 146, duty cycle 145, list 148, job aid 147, or the like. In some embodiments, the instant invention is configured for and being adapted to enable users to define and program one or more food groups 149. In a preferred embodiment, food groups 149 are utilized for navigating grouping one or more food item 144, ingredient, task, reminder, message, process, timer 146, duty cycle 145, list 148, job aid 147, or the like. In other embodiments, one or more food item 144, ingredient, task, reminder, message, process, timer 146, duty cycle 145, list 148, job aid 147, or the like is not associated to a food group 149.

In a preferred embodiment, present invention is configured to utilize Tiles 100. Conventional commercial kitchen timers utilize channels and are typically limited to 2, 4, 8, 12, and 16 channels. Each of these channels represents a food item or ingredient, and limits users to programming up to the set number of channels. Moreover, these conventional commercial kitchen timers typically provide a single light emitting display, such as an LED display, which shows the current time value of a particular channel. There are other conventional models which have dedicated LED displays for each channel, or one display for the time value, and another for the current channel. In an explementary embodiment, the present invention utilizes Tiles 100 in place of the typical channels found on conventional kitchen timers. In some embodiments, Tiles 100 are programed to represent a task, reminder, process, a commercial kitchen appliance, equipment, or the like.

In a preferred embodiment of the instant invention, one or more Tiles 100 are depicted or portrayed on the invention's user interface display unit 30. In an exemplary embodiment, the present invention is configured to utilize a plurality of Tiles 100. In another embodiment of the instant invention, Tiles 100 are configured to utilize and/or portray a unique icon, description, status, timer, duty cycle(s), and action message(s), instance, or the like.

In an exemplary embodiment of the instant invention, a timer 134 represents a standard timer. In some embodiments, a standard timer counts down from a set total time value, displays an alert message, and will complete once the final message is cleared by a user. In some embodiments, the alert message request an user for an action or an input. In some embodiments the alert messages 423 is portrayed in a different window and not included in a tile 100. In some embodiments the alert message is portrayed in a tile 100. In other embodiments, a timer 134 represents a daily based timer. In some embodiments, a daily based timer is configured to provide the user with an alert or presenting a message on the display unit 30 on specified days and/or times which are programable and configured by a user. In some embodiments of the instant invention, a timer 134 represents a continuous timer which are timers that repeat at user specified intervals.

In some embodiments of the instant invention, an icon 132 is a visual representation of the item the time or value is related to and can represent a food item, ingredient, piece of equipment/device, task, or reminder.

In other embodiments of the present invention, a description 135 is the product, ingredient, task, or reminder name, or when using sensors with the SMART KITCHEN TIMER 10, in some embodiments this is the name of the sensor or piece of equipment associated with the sensor.

In some embodiments of the instant invention, a status 133 represents the current state or status of the Tile 100. For example, status in various embodiments represents inactive Tiles 100 which currently do not have a running timer in a blue color; green Tiles 100 represent Tiles 100 that are currently counting down and have not yet reached the halfway mark; Tiles 100 showing a sensor reading within range in some embodiments also are green; or when a Tile 100 with a sensor produces a reading outside of the specified range, the Tile 100 will turn red; and once a timer reaches the halfway point, the Tile 100 will turn yellow. In other embodiments, a time value 134 represents the total time or time remaining, or if using an external device, such as a sensor, the current value is displayed. In some embodiments, an instance 131 indicates the number of Tiles 100 currently active (e.g., running or counting up/down) in a single Tile 100.

In some embodiments of the present invention, the Tiles 100 are dynamic Tiles 120. In other embodiments of the instant invention, the Tiles 100 are static Tiles 110. In some embodiments, dynamic Tiles 120 display the same information as static Tiles 110, but do not display the number of instances 131.

In an exemplary embodiment of the instant invention, the display 30 includes an area dedicated to portraying both static 110 and dynamic Tiles 120. In other embodiments of the present invention, the display unit includes a Playfield 122. Yet in another embodiment, the display unit 30 features a static list of Tiles on the left side of the screen which when enabled populate the “playfield” 122 in the center of the screen. In another embodiment, the present invention utilizes both one or more static Tile 110 and one or more dynamic Tiles 120.

In some embodiments, when a user touches a tile 100 via the display 30, the display presents a pop-up window, such as a virtual keyboard. In other embodiments, when a user touches a tile 100 via the display 30, the display presents an information window. Yet in other embodiments, when a user touches a tile 100 via the display 30, the display presents a pop-up window enabling the user to pair sensors to the SMART KITCHEN TIMER 10.

In some embodiments, the SMART KITCHEN TIMER 10 includes an indicator 137 on the display 30. In some embodiments, when a user touches the display 30 corresponding to the indicator 137, the SMART KITCHEN TIMER 10 presents the user with one or more pop-up windows. In some embodiments, when a user touches the display 30 corresponding to the indicator 137, the SMART KITCHEN TIMER 10 presents the user with one or more pop-up windows instructing the user in a series of steps, such as a firmware update process. In some embodiments, a tile 100 is a selectable tile 100. In other embodiments, when a user touches the display 30 corresponding to the tile 100, the SMART KITCHEN TIMER 10 presents the user with one or more pop-up windows.

In an exemplary embodiment, the present invention is capable of being configured and programed via a Configuration Tool 300. In some embodiments, the Configuration Tool 300 is accessed wirelessly via a web browser or the like. In some embodiments of the instant invention, the SMART KITCHEN TIMER 10 enables a user to create/program a plurality of product/process timers, task reminders, alerts messages, day parts, and/or job aids. In another embodiment, the instant invention is programed by uploading a master configuration file. Yet in another embodiment, the mater configuration file is installed on the present invention either directly via flash drive, or remotely through a cloud (e.g., a network of servers). In other embodiments, the SMART KITCHEN TIMER 10 is integrated with a cloud computing network or environment 320 and is programed via the cloud computing network or environment. In some embodiments, a configuration file is installed/downloaded to the SMART KITCHEN TIMER 10 via the cloud computing network or environment. In one embodiment of the instant invention, the cloud computing network or environment 320 is a proprietary cloud computing network, such as the Reneu Cloud.

In other embodiments of the present invention, the configuration file includes a plurality of configuration files. In some embodiments, the configuration file includes a public configuration file. In other embodiments, the configuration file includes a private configuration file. Yet in other embodiments of the instant invention, the configuration file includes both a public and private configuration file. In some embodiments, when a configuration file is pushed to the SMART KITCHEN TIMER 10, the already configured, or paired to the respective SMART KITCHEN TIMER system, sensors are not affected.

In one embodiment of the instant invention, wireless sensors are monitored though a cloud computing network or environment 320. In one embodiment of the instant invention, the cloud computing network or environment 320 is a proprietary cloud computing network, such as the Reneu Cloud. In other embodiments, wireless sensors are monitored though a cloud computing network or environment 320 and a SMART KITCHEN TIMER 10.

In one embodiment of the instant invention, a USB dongle is inserted on a USB port 50 on the SMART KITCHEN TIMER 10. In some embodiments, the USB dongle is a Wi-Fi dongle that when inserted into a USB port 50 on the SMART KITCHEN TIMER 10, enables a user to wirelessly connect to the SMART KITCHEN TIMER 10 via a Service Set Identifier (“SSID”). In another embodiment, the Configuration Tool is accessed wireless, via a web browser, by navigation to the SSID screen on the SMART KITCHEN TIMER and connecting a computer to the uniquid SSID. In some embodiments, once connected via the SSID, the Configuration Tool 300 is used to add and edit programming, such as groups, items, timers, Job Aids, and pair wireless sensor modules and gateways and mini gateways.

In some preferred embodiments, the instant invention is configured to utilize job aids 147. In some embodiments, job aids 147 assist in employee training. In some embodiments, a job aid 147 is a build card. In some embodiments, a job aid 147 is a process or procedure that instructs the user necessary steps to perform equipment cleaning. In some embodiments, a job aid presents a process or procedure in window 422 on the display 30. In some embodiments, a job aid 147 a process or procedure that instructs the user necessary steps to perform equipment trouble shooting. In some embodiments of the instant invention, a SMART KITCHEN TIMER 10 receives one or more configuration parameter associated with a job aid 147 from a user or configuration file. In some embodiments, a job aid 147 includes one more configuration data set. In another embodiment, the present invention is configured for and being adapted to enable users to define and program one or more job aid 140. In some embodiments, a job aid 147 is uploaded to the instant invention via a Configuration Tool 300. Yet in other embodiments, a job aid 147 includes a name, one or more labels, an icon, one or more text messages, and/or an action icon. In some embodiments of the instant invention, a job aid 147 is depicted in a first layout. In other embodiments, a job aid 147 is depicted in a second layout. In some embodiments, a job aid 147 is depicted in a plurality of layouts. In some embodiments, a job aid 147 is depicted in a plurality of layouts. In some embodiments, a job aid 147 includes a job aid name, a first label, a second label, an icon, a top text, a bottom text, or an action icon.

In another embodiment, the present invention utilizes icons 132, such as a logo or image. In some embodiments, an icon 132 is uploaded to the instant invention via a Configuration Tool 300. In other embodiments, an icon 132 is provided via an Icon Library. In some embodiments of the present invention, an icon 132 is a live or animated image.

In an exemplary embodiment of the instant invention, the present invention is configured to pair with one or more additional SMART KITCHEN TIMERs 10. In some embodiments, the SMART KITCHEN TIMER 10 is a primary SMART KITCHEN TIMER 10. In some embodiments, the one or more additional SMART KITCHEN TIMERs 10 are programed via a configuration file from a primary SMART KITCHEN TIMER 10. In some embodiments of the present invention, a SMART KITCHEN TIMER 10 is a master SMART KITCHEN TIMER. In other embodiments of the instant invention, a SMART KITCHEN TIMER 10 is a slave SMART KITCHEN TIMER. Yet in another embodiment of the present invention, Items 140 are transferred from a primary SMART KITCHEN TIMER 10 to a one or more additional SMART KITCHEN TIMERs 10. In other embodiments, configuration files are transferred from a primary SMART KITCHEN TIMER 10 to a one or more additional SMART KITCHEN TIMERs 10.

In some embodiments of the instant invention, the SMART KITCHEN TIMER 10 includes a basic software application (“SKT Basic”). In some embodiments, a SKT Basic software application includes a basic user interface application screen. In other embodiments, the SMART KITCHEN TIMER 10 includes a basic software application and a basic user interface application screen 138. In other embodiments, the SMART KITCHEN TIMER 10 includes an advanced software application (“SKS Hub”). In other embodiments, a SKS Hub software application comprises an advanced user interface application screen 139. In other embodiments, the SMART KITCHEN TIMER 10 includes an advanced software application and an advanced user interface application screen. In some embodiments, the SMART KITCHEN TIMER 10 comprises a SKT Basic software application and a SKS Hub software application. In a preferred embodiment of the instant invention, the SMART KITCHEN TIMER is configured to allow a user to toggle between a SKT Basic software application and a SKS Hub software application.

In some embodiments of the instant invention, the SKS Hub software application is configured with an external configuration tool 300. In some embodiments, the SKS Hub software application is configured for firmware updates with a USB device that is inserted into the USB port 50. In some embodiments, the SKS Hub software application is configured for uploading configuration file with a USB device that is inserted into the USB port 50. In some embodiments, the SKS Hub software application is wirelessly connected to a cloud computing network or environment 250 and electronically communicates with a cloud computing network or environment 250. In some embodiments, the SKS Hub software application is wirelessly communicates with a plurality of external devices 40. In other embodiments, the SKS Hub software application receives information and records, such as HACCP records. In other embodiments, the SKS Hub software application is configured to receive information and data for groups 149. In other embodiments, the SKS Hub software application is configured to receive Job Aid 147 information and data. In some embodiments, the SKS Hub software application is configured to receive icon 132 information and data. In some embodiments, the SKS Hub software application is configured to receive transfer function information and data. In some embodiments, the SKS Hub software application is configured for multi-grid support.

In an exemplary embodiment of the instant invention, the SMART KITCHEN TIMER 10 using the SKS Hub software application interfaces and communicates with external devices, such as a printer. Yet in other embodiments, one or more SMART KITCHEN TIMERS 10 each using the SKS Hub software application interfaces and communicates with external devices, such as a printer. In some embodiments, the SMART KITCHEN TIMER 10 using the SKS Hub software application interfaces with external devices via a wireless connection, such Wi-Fi or Bluetooth. In other embodiments, a user utilized the SMART KITCHEN TIMER 10 using the SKS Hub software application interface with external devices, such as a printer.

In other embodiments, the SKT Basic software application is configured for on device programming via the user interface 30. In some embodiments, the SKT Basic software application is configured for firmware updates with a USB device that is inserted into the USB port 50. In some embodiments, the SKT Basic software application is configured for uploading configuration file with a USB device that is inserted into the USB port 50. In other embodiments, the SKT Basic software application is configured to receive information and data for groups 149. In some embodiments, the SKT Basic software application is configured for multiple graphical themes.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A kitchen control system for creating an item and assisting users in preparing the item, the system comprising:
a smart kitchen timer, the smart kitchen timer comprising:
an electronic display unit;
a computing environment including at least one computer-readable storage medium having program instructions stored therein and a computer processor operable to execute the program instructions to cause the smart kitchen timer to perform operations comprising:
receiving from a user, an item type instruction;
developing a configuration profile for the item type;
requesting from the user at least one configuration parameter, wherein the at least one configuration parameter is associated with the item type;
receiving from the user the one or more configuration parameter; and
developing a first tile configuration profile, wherein the first tile configuration profile includes a plurality of instructions associated with the item type; and
generating a first selectable tile in a portion of display unit, the first selectable tile displaying at least one instruction of the plurality of instructions associated with the item type.

2. The kitchen control system as claimed in claim 1, further comprising one or more sensors positioned at a first location and configured to obtain information of a first kitchen appliance.

3. The kitchen control system as claimed in claim 2, further comprising generating an output parameter associated with the information of the first kitchen appliance.

4. The kitchen control system as claimed in claim 1, wherein the item type instruction includes information for a first food item.

5. The kitchen control system as claimed in claim 4, wherein the information for the first food item comprises:
an item name;
a first item duty cycle;
a message; and
an item icon.

6. The kitchen control system as claimed in claim 1, wherein the item type instruction includes information for a first job aid.

7. The kitchen control system as claimed in claim 6, wherein the information for the first job aid comprises:
a first label;
a product icon;
a first text message;
a second text message; and
an action icon.

8. The kitchen control system as claimed in claim 1, wherein the item type instruction includes information for a first message.

9. The kitchen control system as claimed in claim 8, wherein the information for the first message comprises:
a message label;
an icon;
a first text message; and
a dynamic output.

10. The kitchen control system as claimed in claim 1, wherein the first selectable tile is a static tile.

11. The kitchen control system as claimed in claim 1, wherein the first selectable tile is dynamic tile.

12. The kitchen control system as claimed in claim 1, wherein the developing a first tile configuration profile includes determining one or more limits based on the configuration profile for the item type.

13. The kitchen control system as claimed in claim 1, wherein developing a first tile configuration profile includes determining an item status condition, the item status condition being developed based on an evaluation of the item type and the one or more limits.

14. A method of preparing an item, the method comprising:
receiving from a user, an item type instruction;
developing a configuration profile for the item type;
requesting from the user at least one configuration parameter, wherein the at least one configuration parameter is associated with the item type;
receiving from the user the one or more configuration parameter; and
developing a first tile configuration profile, wherein the first tile configuration profile includes a plurality of instructions associated with the item type; and
generating a first selectable tile in a portion of display unit, the first selectable tile displaying at least one instruction of the plurality of instructions associated with the item type.

15. The method as claimed in claim 14, The kitchen control system as claimed in claim 1, wherein the item type instruction includes information for a first food item.

16. The method as claimed in claim 15, wherein the information for the first food item comprises:
an item name;
a first item duty cycle;
a message; and
an item icon.

17. The method as claimed in claim 14, wherein the item type instruction includes information for a first job aid.

18. The method as claimed in claim 17, wherein the information for the first job aid comprises:
a first label;
a product icon;
a first text message;
a second text message; and
an action icon.

19. The method as claimed in claim 14, wherein the item type instruction includes information for a first message.

20. The method as claimed in claim 19, wherein the information for the first message comprises:
a message label;
an icon;
a first text message; and
a dynamic output.

21. The method as claimed in claim 14, wherein the developing a first tile configuration profile includes determining one or more limits based on the configuration profile for the item type, and wherein developing a first tile configuration profile includes determining an item status condition, the item status condition being developed based on an evaluation of the item type and the one or more limits.
